(19) United States
(12) Patent Application Publication
(10) Pub. No.: US 2022/0256866 A1
(43) Pub. Date: Aug. 18, 2022

(54) METHOD OF EXTENDING BREAD SHELF LIFE

(71) Applicant: Givaudan SA, VERNIER (CH)

(72) Inventors: Kim Par TOH, Singapore (SG); Lock Yang PHUA, Singapore (SG)

(21) Appl. No.: 17/628,990

(22) PCT Filed: Aug. 12, 2020
(86) PCT No.: PCT/EP2020/072679

§ 371 Date: Jan. 21, 2022

Related U.S. Application Data
(60) Provisional application No. 62/886,597, filed on Aug. 14, 2019.

(51) Int. Cl. A21D 2/16; A21D 2/18

(52) U.S. Cl. CPC A21D 2/165; A21D 2/188; A21D 2/183; A21D 2/16

(57) ABSTRACT

A method of extending the shelf life of a baked bread product containing wheat flour, includes providing for addition to a dough mix containing at least a portion of the wheat flour in the baked bread product recipe, an integrated shelf life extender composition which comprises in weight percent based on the total weight of the shelf life extender composition:
a) about 10 wt. % to about 80 wt. % of at least one fat composition;
b) about 1 wt. % to about 10 wt. % of at least one hydrocolloid adsorbent;
c) about 1 wt. % to about 5 wt. % of at least one glyceride;
d) about 1 wt. % to about 5 wt. % of at least one dough strengthener;
e) about 1 wt. % to about 10 wt. % of at least one flavour component.

The integrated shelf life extender composition is added to the dough mix in an amount of about 0.5 wt. % to about 2 wt. %, based on the total weight of the baked bread product recipe. The dough mix containing the shelf life extender composition is thereafter incorporated into the baked bread product recipe in a particular embodiment, the baked bread product is white bread.

The present disclosure is directed to a method of extending the shelf life of baked bread products containing wheat flour, such as white bread, up to at least seven (7) days.

Bread is one of the oldest prepared foods, and is a staple food article nearly worldwide. Modern bread production methods use mechanical working of dough to reduce the fermentation period and the time taken to produce a loaf. The process is widely used around the world in large factories. As a result, bread can be produced very quickly and at low costs to the manufacturer and the consumer.

Bread is, however, a dynamic system, which experiences ongoing physical, chemical and microbiological changes that limit its shelf life. Physical and chemical changes result in the loss of freshness, evidenced by changes in texture and taste, and the progressive firming of the crumb. Microbiological changes result in the formation of off-flavours, production of invisible mycotoxins and visible mold growth. Bread staling results in food waste, and economic losses for both the producer and consumer. To avoid the sale and consumption of stale bread, certain producers voluntarily remove bread from retail shelves within less than five (5) days of baking.

Extending the shelf life of bread from five (5) to at least seven (7) days results in a tremendous economic benefit to both the producer and the consumer, by extending the viable retail life and consumption period for the baked bread product.

The disclosed method was developed to solve the short shelf life of bread, exemplified by white sandwich bread, by extending the shelf life from 5 days to 7 days. This method results in maintaining the texture, moisture, flavor retention and perception of freshness in bread for at least up to 7 days.

This method enables the bread manufacturer to utilize an optimal combination of ingredients in an integrated shelf life extender composition that leads to better performance in this bread application. Further, the method eliminates the need to source from different ingredient manufacturers, and to determine and measure the dosages of each individual ingredient resulting, in combination, in shelf life extension, to be used during the dough making process.

The present subject method solves the short shelf life of bread in the grocery/retail market. Currently, unsold bread may be taken off the shelf after two to three days. The extended shelf life not only improves the economic lifespan (and reduce wastage) on the distribution chain, it also demonstrates better flavor retention in bread with both sensorial (fresh bread perception) and physical synergy between the flavour, emulsifiers and stabilizers in the bread matrix. It minimizes the effects of stating while maintaining the texture and moisture.

The subject method utilizes an integrated shelf life extender composition as a novel delivery system to provide better dispersion of emulsifiers, stabilizers and flavours, thus creating an ease of use during the dough making process. By using the subject method and its integrated delivery system composition, bread manufacturers do not have to mix and match, pre-weigh various ingredients, and create premixes or keep an inventory of all these individual ingredients.

There is no current technology available to solve all the problem of extended shelf life yet maintain freshness and texture in bread. Alternative solutions are “either/or” and not “all-in”. For instance, a particular ingredient is able to extend the bread shelf life and prevent mold but may not be able to keep the bread texture “soft and moist”. Similarly using a stabilizer ingredient could make the bread soft in texture, but may impart an oily, off-tasting note. Adding a flavour may improve the sensory attribute (of a fresh bread), but alone does not guarantee an extended shelf life.

The subject method provides all the benefits mentioned above by the use of an integrated shelf life extender composition as disclosed herein.

### BRIEF DESCRIPTION OF THE DRAWINGS

FIGS. 1 and 2 are graphical representations of the comparison of bread texture/firmness with and without the subject integrated shelf life extender composition.

FIGS. 3 and 4 are graphical representations of the comparison of bread moisture with and without the subject integrated shelf life extender composition.

FIGS. 5 and 6 are graphical representations of the comparison of bread water activity with and without the subject integrated shelf life extender composition.

FIG. 7 is a graphical representation of the sensory panel results, where the y-axis represents the score of preference and the x-axis represent the descriptors provided by the sensory panel.

There is provided a method of extending the shelf life of a baked bread product containing wheat flour, comprising providing for addition to a dough mix containing at least a portion of the wheat flour in the baked bread product recipe, an integrated shelf life extender composition which comprises in weight percent based on the total weight of the shelf life extender composition:
a) about 10 wt. % to about 80 wt. % of at least one fat composition;
b) about 1 wt. % to about 10 wt. % of at least one hydrocolloid adsorbent;
c) about 1 wt. % to about 5 wt. % of at least one glyceride;
d) about 1 wt. % to about 5 wt. % of at least one dough strengthener;
e) about 1 wt. % to about 10 wt. % of at least one flavour component.

The method may further include adding to the dough mix about 0.5 wt. % to about 2 wt. % of the shelf life extender composition, based on the total weight of the baked bread product recipe. The dough mix containing the shelf life extender composition may thereafter be incorporated into the baked bread product recipe. In a particular embodiment, the baked bread product is white bread.

In certain embodiments, the fat composition may be at least one of palm olein, palm fat, palm shortening, palm stearin, refined, deodorized and bleached palm oil, vegetable oil, canola oil, sunflower oil, coconut oil, or a fatty acid selected from palmitic acid, stearic acid, oleic acid, linoleic acid and lauric acid. The fat or oil composition serves in part as a medium to suspend the other components of the shelf life extender composition, such as the hydrocolloid (e.g., gums). It contributes to functions such as a solvent, in flavor delivery, as a dough conditioner, a dough softener and a water activity controller. The fat composition in the delivery system composition varies from about 10 wt. % to about 80 wt. % of the delivery system composition as a single fat compound or a combination of different ratios of fat compounds.

In certain embodiments, the adsorbent is at least one of a hydrocolloid selected from a gum, carboxymethyl cellulose, hydroxypropyl methylcellulose, inulin cellulose, or, alpha, beta, or gamma cyclodextrins singly or in combination, and oligosaccharides. The gum may be selected from xanthan gum, guar gum, tara gum, acacia gum, tragacanth gum, karaya gum, locust bean gum, gellan gum, and cellulose gum. The hydrocolloid adsorbent functions as a water binding media to hold onto some of the water in the system and to keep the bread moist. The hydrocolloid adsorbent composition varies from about 1 wt. % to about 10 wt. % of the delivery system composition as single compound or a combination of different hydrocolloids, such as carboxymethyl cellulose (CMC) and/or gums.

In certain embodiments, the glyceride is at least one of a monoglyceride, a diglyceride, or a medium chain triglyceride, of at least one fatty acid. Medium chain triglycerides (MCTs) are triglycerides with two or three fatty acids having an aliphatic tail of 6 to 12 carbon atoms, i.e., medium chain fatty acids. In certain embodiments, the tri-ester glyceride compositions may include caprylic acid (50-65 wt. %) and capric acid (30-45 wt. %). In some embodiments, low amounts of caproic acid (≤2 wt. %) and lauric acid (≤2 wt. %) may be present in the medium chain triglyceride. In particular embodiments, the glyceride used is a distilled mono glyceride (DMG), or a combination of mono-diglycerides of fatty acids.

Glycerides function as a softener and help to retard retrogradation of the starch in the bread. The glycerides function as an emulsifier, dough softener and conditioner. The glycerides slow down starch retrogradation (staling) which causes bread to turn stale, dry, and hard, and to crumble easily. The glycerides may vary from about 1 wt. % up to about 5 wt. % of the delivery system composition, as a single compound or a combination of different glycerides.

In certain embodiments, the dough strengthener is at least one of sodium stearoyl lactylate (SSL), albumin, or egg protein. Sodium steroyl lactylate is a particularly effective strengthener when used in the integrated shelf life extender composition. When more water is added into the bread dough recipe to facilitate processing, the addition can potentially weaken the resulting bread structure. SSL enables the addition of extra water in a dough recipe by giving a strengthening effect to the bread system during processing, without weakening the bread structure after baking. This increases the moisture and a perceived softer texture in the baked bread. The strengthener, such as SSL, may vary from about 1 wt. % up to about 5 wt. % of the delivery system composition.

In certain embodiments, the flavour component is at least one of fatty acids, lactic acid, propionic acid, lactones, aldehydes, diketones, pyrazines, thiazoles, furfural, acetyl furan, maltol, amino acids or dairy cultures. Effective flavours may have a breadcrust profile, and these ingredients are typical of giving baked, crusty notes. Suitable amino acids include proline, cysteine, and glycine. Lactic acid (formula CH₃CH(OH)CO₂H) is extremely soluble in water, and is responsible for the sour flavor of sourdough bread. Propionic acid is a naturally occurring carboxylic acid (formula CH₃CH₂CO₂H).

Flavours mask the floury note resulting from the flour used, and provide flavour enhancement to the bread to compensate for any flavour loss due to prolonged storage. The flavours may impart to the bread, a sensorial experience of freshly baked bread, even after 7 days of shelf life. The flavour component may vary from about 1 wt. % up to about 10 wt. % of the delivery system composition, as a single flavor compound or a combination of different flavor compounds.

In certain embodiments, the shelf life extender composition is described in the table below.

| | Amount In g/kg |
|---|---|
| Palm oil | 723.5~763.5 |
| Mono glyceride | 38.0 |
| Sodium Stearoyl Lactylate | 38.0 |
| Carboxymethyl Cellulose | 100.0 |
| Tocopherol | 0.5 |
| Flavouring | 60~100.0 |
| Total | 1000.0 |

In certain embodiments, about 0.5 wt. % to about 2 wt. % of the shelf life extender composition, based on the total weight of the baked bread product recipe, is used. In some embodiments, about 0.5 wt. % to about 1 wt. % of the shelf life extender composition, based on the total weight of the baked bread product recipe, is used. In particular embodiments, about 1 wt. % of the shelf life extender composition, based on the total weight of the baked bread product recipe, is used. A lower dosage may reduce the functionality of the additives used, and thus will affect the absorption of the water used in the recipe. A higher dosage could potentially over-dose the flavour used in the recipe.

The method shelf life extender composition may be added as the delivery system composition to an initial dough mix. The dough mix containing the shelf life extender composition may thereafter be incorporated into the baked bread product recipe.

For example, and not by way of limitation, the dough for the baked bread product recipe may typically comprise water, wheat flour, wheat gluten, sugar and/or other sweetener(s), eggs, milk or milk powder, vegetable oil, Baker's yeast and/or other leavening agent(s), oligosaccharides, fibre, minerals and vitamins (ammonium sulphate, sodium chloride, potassium chloride, calcium sulphate, calcium propionate, iron, thiamine, riboflavin, niacin), depending on the type of bread desired. Other flours and other typical bread ingredients may be included in the recipe, as desired. Such other flours may include rye, oat, barley, as well as those used in gluten free bread, such asmillet, sorghum, quinoa, arrowroot, corn starch, rice flour, tapioca flour, and potato flour.

In one embodiment, the integrated shelf life extender composition used in the subject method may be made by the method comprising:
melting the at least one fat composition, optionally comprising oil as disclosed above;
adding the glyceride and dough strengthener to the melted fat/oil composition with agitation or high shear mixing to forma liquid oil phase;
adding the hydrocolloid adsorbent and optionally the at least one flavour to the liquid oil phase with mixing or agitation to form a homogenized continuous oil phase; and,
allowing the homogenized continuous oil phase to cool and solidify.

In some embodiments, sodium steroyl lactylate (SSL) is added with the glyceride. The hydrocolloid adsorbant is added under agitation until homogenous or well dispersed in the continuous oil phase. The homogenized continuous oil phase is packaged in a container and may be allowed to cool and solidify in the packaging container.

The shelf life extender composition, produced in this manner, may be made by a batch mixing process in a heat jacketed vessel, including heating the vessel for melting the at least one fat composition by hot water and/or steam circulation in the vessel jacketing.

In another embodiment, the integrated shelf life extender composition used in the subject method may be made by the method comprising:
melting the at least one fat composition, optionally comprising oil as disclosed above;
adding sequentially to the melted fat/oil composition with agitation or high shear mixing;
a) the glyceride and the dough strengthener.
b) the flavour, water and other water soluble ingredients, and
c) the hydrocolloid adsorbent.
to form a dispersed aqueous phase water-in-oil emulsion in a continuous non-aqueous phase; and,
crystallising the continuous non-aqueous phase by cooling to form a viscous paste. The dispersed aqueous phase water-in-oil emulsion in the continuous non-aqueous phase may be passed through a dynamic scraped surface heat exchanger to form the viscous paste.

The principles of stabilization of water-in-oil emulsions are well known to the art, and the skilled person will readily comprehend what is required in each case, or can determine what is needed by simple, non-inventive routine experimentation. There is available to the art a considerable number of these, of different physical characteristics and manufacturing capabilities, and the selection of a suitable material or combination is within the skill of the art.

Examples of other water soluble ingredients that may be added with the water in the aqueous phase include, but are not limited to, coloring, citric acid, potassium sorbate, and flavours such as vanillin, ethyl vanillin, maltol, ethyl maltol, furanol, caramel, molasses, gula Melaka, (a caramelized sugar extracted from palm tree), maple syrup, pandan extract, and the like.

Also provided is a method of making a baked bread product containing wheat flour, having an extended shelf life of up to at least 7 days, comprising
preparing a sponge mix containing wheat flour by mixing the wheat flour and other ingredients thereof;
proofing the sponge mix;
adding to a dough mix containing at least a portion of the wheat flour in the baked bread product recipe, an integrated shelf life extender composition which comprises in weight percent based on the total weight of the shelf life extender composition.
a) about 10 wt. % to about 80 wt. % of at least one fat composition;
b) about 1 wt. % to about 0 wt. % of at least one hydrocolloid adsorbent;
c) about 1 wt. % to about 5 wt. % of at least one glyceride;
d) about 1 wt. % to about 5 wt. % of at least one dough strengthener;
e) about 1 wt. % to about 10 wt. % of at least one flavour component;
mixing the dough mix containing the shelf life extender composition with the proofed sponge mix;
mixing a shortening component into the dough mix/sponge mix mixture;
optionally moulding the shortening modified dough mix/sponge mix mixture;
proofing the shortening modified dough mix/sponge mix mixture; and,
baking the proofed, shortening modified dough mix/sponge mix mixture.

The integrated shelf life extender composition used in the method of making the baked bread product may be made by either the homogenized continuous oil phase or dispersed aqueous phase water-in-oil emulsion in a continuous non-aqueous phase preparation method embodiments disclosed above.

### EXAMPLES

### Example 1. Integrated Delivery System Made by a Batch Mixing Process, Continuous Fat Phase

Formulation in a continuous fat phase:

| | Amount in g/kg |
|---|---|
| Palm oil | 723.5 |
| Mono glyceride | 38.0 |
| Sodium Stearoyl Lactylate | 38.0 |
| Carboxymethyl Cellulose | 100.0 |
| Tocopherol | 0.5 |
| Flavouring | 100.0 |
| Total | 1000.0 |

Samples of the integrated delivery system comprising the shelf life extender composition were prepared by a batch mixing process in a heat jacketed vessel. The tank was heated by hot water recirculation in the jacketed tank to melt the oils/fats. The glyceride emulsifier and sodium stearoyl lactylate strengthener were then added into the oil under agitation. High shear mixing was done by a Silverson®, Polytron® or Stephan® mixer. In the melted liquid oil phase, hydrocolloid(s) (carboxymethyl cellulose) and flavourings (including tocopherol) were then added and further mixed. Once homogenized, the composition was packed into containers and left to cool down naturally. The liquid oil mixture solidified over time in the packaging.

### Example 2. Integrated Delivery System Made by a Water-In-Oil Emulsion Continuous Mixing Process Having a Dispersed Aqueous Phase in a Continuous Non-Aqueous Phase

Formulation in a water-in-oil emulsion:

| | Amount in g/kg |
|---|---|
| Non aqueous phase | |
| Mixture of palm oil, palm | 694.8 |
| stearin and sunflower oil | |
| Mono glyceride | 40.0 |
| Sodium Stearoyl Lactylate | 40.0 |
| Carboxymethyl Cellulose | 113.9 |
| Flavor oil | 80.0 |
| Aqueous phase | |
| Water | 30.2 |
| Coloring | 0.1 |
| Potassium sorbate | 1.0 |
| Citric acid solution | adjusted to pH 4.5 |
| Total | 1000.00 |

Samples of the integrated delivery system comprising the shelf life extender composition were prepared by a continuous mixing process: Oils/fats were heated in the tank, followed by glyceride emulsifier(s) and sodium stearoyl lactylate strengthener, flavours, hydrocolloids (carboxymethyl cellulose) and other aqueous phase ingredients under agitation. The mixture was then passed through a scrape surface heat exchanger where in the final cooling step, the fats and oils were crystallized, thus producing a thick viscous paste which was filled and packed into a container.

White Bread Recipe: The baked bread recipes, one without the subject shelf life extender composition (control) and another with the subject shelf life-extender composition, were used.

### Comparative Example 3. White Sandwich Bread without Integrated Shelf Life Extender Composition

| | Baker's % | True % |
|---|---|---|
| Sponge Mix | | |
| Sponge Flour | 70 | 38.40 |
| Water (* Based on Sponge Flour) | 60 | 23.00 |
| Instant Yeast (High Sugar) | 2 | 1.00 |
| Dough Mix | | |
| Dough Flour | 30 | 16.8 |
| Milk Solid Non Fat | 3 | 1.7 |
| Water (* Based on Total Absorption) | 65 | 12.6 |
| Salt | 1.5 | 0.8 |
| Sugar | 6 | 3.3 |
| Shortening | 4 | 2.2 |
| Dough Improver | 0.5 | 0.3 |
| Calcium Propionate | 0.3 | 0.2 |
| Total Dry Weight | 182.3 | 100.0 |

### Example 4. White Sandwich Bread with Integrated Shelf Life Extender Composition

| | Baker's % | True % |
|---|---|---|
| Sponge Mix | | |
| Sponge Flour | 70 | 38.70 |
| Water (* Based on Sponge Flour) | 60 | 23.20 |
| Instant Yeast (High Sugar) | 2 | 1.00 |
| Dough Mix | | |
| Dough Flour | 30 | 16.6 |
| Water (*Based on Total Absorption) | 65 | 12.7 |
| Salt | 1.5 | 0.8 |
| Sugar | 6 | 3.3 |
| Shortening | 4 | 2.2 |
| Dough Improver | 0.5 | 0.3 |
| Calcium Propionate | 0.3 | 0.2 |
| Extender Composition | 1.8 | 1.0 |
| Total Dry weight | 181.1 | 100.0 |

### Comparative Example 5. White Sandwich Bread without Integrated Shelf Life Extender Composition

| | Baker's % | True % |
|---|---|---|
| Sponge Mix | | |
| Sponge Flour | 70 | 37.98 |
| Water (* Based on Sponge Flour) | 60 | 22.79 |
| Instant Yeast (High Sugar) | 2 | 1.09 |
| Dough Mix | | |
| Dough Flour | 30 | 16.28 |
| Milk Solid Non Fat | 3 | 1.63 |
| Water (*Based on Total Absorption) | 67 | 13.56 |
| Salt | 1.5 | 0.81 |
| Sugar | 6 | 3.26 |
| Shortening | 4 | 2.17 |
| Dough Improver | 0.5 | 0.27 |
| Calcium Propionate | 0.3 | 0.16 |
| Extender Composition | 0.0 | 0.00 |
| Total Dry weight | 184.3 | 100.0 |

### Example 6. White Sandwich Bread with Integrated Shelf Life Extender Composition

| | Baker's % | True % |
|---|---|---|
| Sponge Mix | | |
| Sponge Flour | 70 | 37.02 |
| Water (* Based on Sponge Flour) | 60 | 22.21 |
| Instant Yeast (High Sugar) | 2 | 1.06 |
| Dough Mix | | |
| Dough Flour | 30 | 15.86 |
| Milk Solid Non Fat | 3 | 1.59 |
| Water (*Based on Total Absorption) | 70 | 14.81 |
| Salt | 1.5 | 0.79 |
| Sugar | 6 | 3.17 |
| Shortening | 4 | 2.12 |
| Dough Improver | 0.5 | 0.26 |
| Calcium Propionate | 0.3 | 0.16 |
| Extender Composition | 1.80 | 0.00 |
| Total Dry weight | 189.1 | 100.0 |

Examples 5 & 6 bread used a wheat flour grade with 67% water absorption, as analyzed by a Brabender Farinograph.

Method used to make Sandwich Bread: Sponge Mix ingredients were added in an mixing bowl (McDuffy double spiral arm) at No. 1 speed for 2 minutes. It was then transferred onto a greased container and proofed for 2 hours at 28° C./85% relative humidity (RH). After that, the rest of ingredients (except shortening) were added into the mixing bowl and mixed for 30-60 seconds followed by the shortening last. It was further mixed at No. 2 speed until fully developed (<3 min). The dough was rested under cover for 10 minutes, divided into 100 gm pieces then moulded and transferred to a baking pan for proofing at 35° C./85% RH until it reached 90% of the pan height. The proofed loaves were baked at 215-220° C. for 25 minutes. Once baked, the bread was removed immediately from the pan and allowed to cool down to room temperature before packing in polyethylene bags.

Testing of bread samples: The baked bread was tested for texture analysis, water activity, moisture content, microbiology and sensory panel evaluation. Samples with and without the shelf life extender composition from 0, 3, 5 and 8 days were tested side by side.

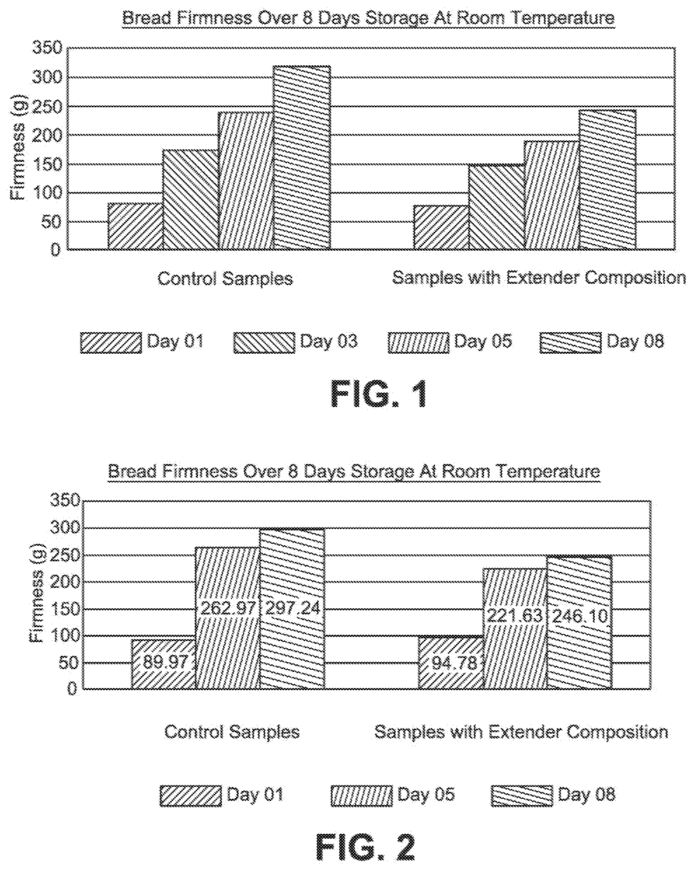

The test method used to measure bread texture was conducted using the AACC 74-09-01 Measurement of Bread Firmness by Universal Testing Machine Method, using the Stable Micro System TAXT Plus series instrumentation. The method quantitatively measures the force required to compress a baked product by a preset distance. The firmness is taken as a measure of freshness and quality. Test results averages for bread loaves of Examples 3-6 are reported in Table 1, and shown in graphical format in FIG. 1 for Examples 3 and 4 (Test #1) and in FIG. 2 for Examples 5 and 6 (Test #2). Bread made using the subject integrated shelf life extender composition had a softer texture after storage than bread made without the integrated shelf life extender composition.

TABLE 1

| | |
|---|---|
| BREAD FIRMNESS | Bread Sample With |
| Control Bread Sample | Extender Composition |

Test

| Day | #1 | #2 | #1 | #2 |
|---|---|---|---|---|
| Day 01 | 80.37 | 89.97 | 76.28 | 94.78 |
| Day 03 | 172.55 | — | 145.80 | — |
| Day 05 | 239.72 | 262.97 | 137.15 | 221.63 |
| Day 08 | 319.13 | 297.24 | 242.22 | 245.10 |

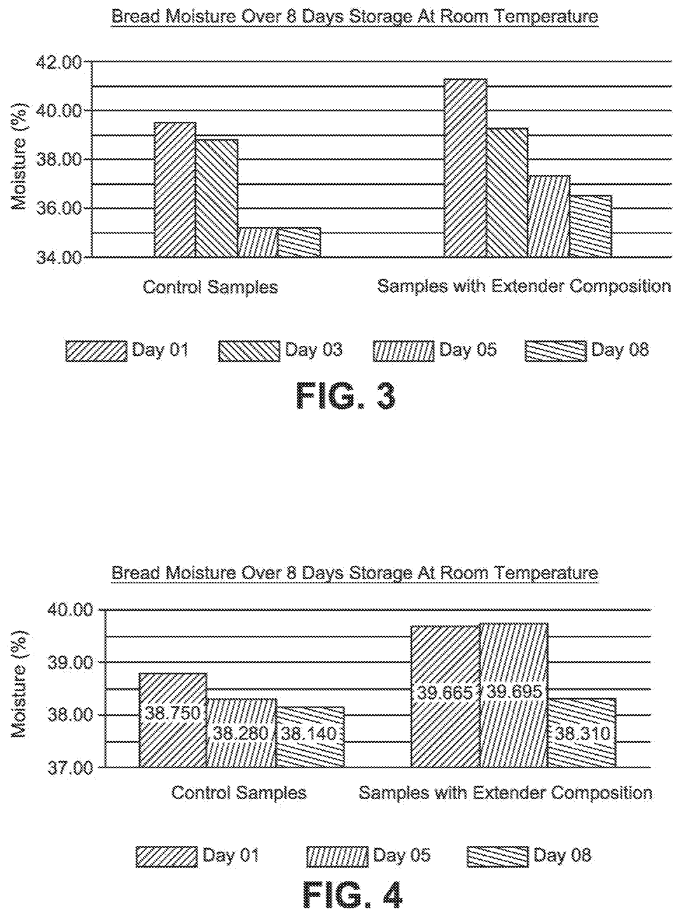

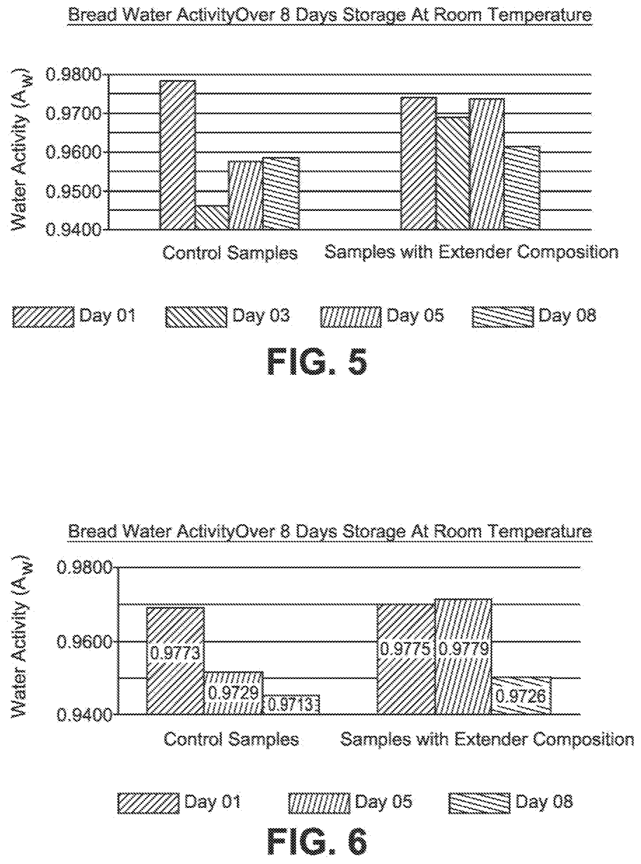

Test results for moisture content and water activity for bread loaves of Examples 3-6 are reported in Table 2. Test results for bread moisture content are shown in graphical format in FIG. 3 for Examples 3 and 4 (Test 1) and in FIG. 4 for Examples 5 and 6 (Test 2). Test results for bread water activity are shown in FIG. 5 for Examples 3 and 4 (Test 1) and in FIG. 6 for Examples 5 and 6 (Test 2). Moisture content was tested using a Mettler HX204 Moisture Analyser based on ASTM E1868-10 (2015) Standard Test Methods for Loss-On-Drying by Thermogravimetry. The bread water activity (aw) was analysed based on ISO 18787: 2017, Foodstuffs—Determination of water activity method using an Aqualab TDL water activity meter from Meter Group. Bread made using the subject integrated shelf life extender composition had a higher moisture content and a more favorable (higher) bread water activity, after storage, than bread made without the integrated shelf life extender composition.

TABLE 2

| | Moisture Content (%) | | Water Activity (aw) | |
|---|---|---|---|---|
| Sample | Test 1 | Test 2 | Test 1 | Test 2 |

Day 01

| | | | | |
|---|---|---|---|---|
| Control | 39.50 | 38.750 | 0.9780 | 0.9773 |
| Extender Modified | 41.28 | 39.605 | 0.9739 | 0.9775 |

Day 03

| | | | | |
|---|---|---|---|---|
| Control | 38.79 | — | 0.9461 | — |
| Extender Modified | 39.25 | — | 0.9689 | — |

Day 05

| | | | | |
|---|---|---|---|---|
| Control | 35.19 | 38.280 | 0.9576 | 0.9729 |
| Extender Modified | 37.34 | 39.695 | 0.9738 | 0.9779 |

Day 08

| | | | | |
|---|---|---|---|---|
| Control | 35.19 | 38.14 | 0.9585 | 0.9713 |
| Extender Modified | 36.48 | 38.31 | 0.9616 | 0.9726 |

### Microbial Testing

Microbial testing from days 1 through 8 were conducted according to the following protocols on bread loaves of Examples 3-6, and are reported in Tables 3.1 and 3.2.

FDA-BAM Online Manual Chapter 3, January 2001
FDA-BAM Online Manual Chapter 4, July 2017
FDA-BAM Online Manual Chapter 5, May 2014
FDA-BAM Online Manual Chapter 4, July 2017
FDA-BAM Online Manual Chapter 18, January 2001

TABLE 3.1
Examples 3 and 4

| | Duration | | | |
|---|---|---|---|---|
| Test Parameters | Day 01 | Day 03 | Day 05 | Day 08 |

Control Bread Sample (Without Extender Composition)

| | | | | |
|---|---|---|---|---|
| Total Aerobic Plate Count: | <10 estimated | <10 estimated | 220 CFU/g | 650 CFU/g |
| | CFU/g | CFU/g | | |
| Total Coliform Count: | <10 CFU/g | <10 CFU/g | <10 CFU/g | <10 CFU/g |
| Salmonella Spp.: | Negative | Negative | Negative | Negative |
| | Per 25 g | Per 25 g | Per 25 g | Per 25 g |
| Total Escherichia Coli Count: | <10 CFU/g | <10 CFU/g | <10 CFU/g | <10 CFU/g |
| Total Yeast Count: | <10 CFU/g | <10 CFU/g | <10 CFU/g | <10 CFU/g |
| Total Mould Count: | <10 CFU/g | <10 CFU/g | <10 CFU/g | <10 CFU/g |

Bread Sample (With Extender Composition)

| | | | | |
|---|---|---|---|---|
| Total Aerobic Plate Count: | <10 estimated | <10 estimated | 4000 CFU/g | 5500 CFU/g |
| | CFU/g | CFU/g | | |
| Total Coliform Count: | <10 CFU/g | <10 CFU/g | <10 CFU/g | <10 CFU/g |
| Salmonella Spp.: | Negative | Negative | Negative | Negative |
| | Per 25 g | Per 25 g | Per 25 g | Per 25 g |
| Total Escherichia Coli Count: | <10 CFU/g | <10 CFU/g | <10 CFU/g | <10 CFU/g |
| Total Yeast Count: | <10 CFU/g | <10 CFU/g | 60 CFU/g | 60 CFU/g |
| Total Mould Count: | <10 CFU/g | <10 CFU/g | <10 CFU/g | <10 CFU/g |

*CFU = Colony Forming Unit

TABLE 3.2
Examples 5 and 6
Control Bread Sample (Without Extender Composition)

| | | | | |
|---|---|---|---|---|
| Total Aerobic Plate Count: | — | — | 110 CFU/g | 1110 CFU/g |
| Total Coliform Count: | — | — | <10 CFU/g | <10 CFU/g |
| Salmonella Spp.: | — | — | Negative | Negative |
| | | | Per 25 g | Per 25 g |
| Total Escherichia Coli Count: | — | — | <10 CFU/g | <10 CFU/g |
| Total Yeast Count: | — | — | 70 CFU/g | 450 CFU/g |
| Total Mould Count: | — | — | <10 CFU/g | <10 CFU/g |

Bread Sample (With Extender Composition)

| | | | | |
|---|---|---|---|---|
| Total Aerobic Plate Count: | — | — | 230 CFU/g | 1110 CFU/g |
| Total Coliform Count: | — | — | <10 CFU/g | <10 CFU/g |
| Salmonella Spp.: | — | — | Negative | Negative |
| | | | Per 25 g | Per 25 g |
| Total Escherichia Coli Count: | — | — | <10 CFU/g | <10 CFU/g |
| Total Yeast Count: | — | — | 20 CFU/g | 10 CFU/g |
| Total Mould Count: | — | — | <10 CFU/g | <10 CFU/g |

*CFU = Colony Forming Unit

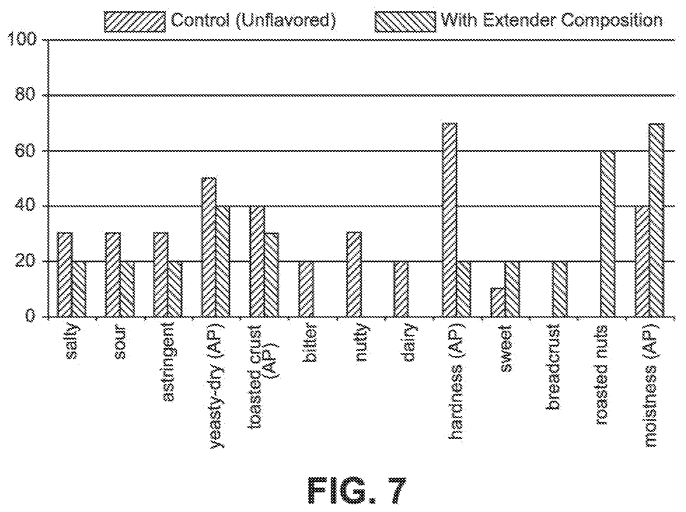

The sensory panel results for the bread loaves of Examples 5 and 6 are provided in FIG. 7, where the y-axis represents the score of preference and the x-axis represent the descriptors provided by the sensory panel. From the sensory descriptor analysis, it was found that the use of the extender composition provides a perceivably greater breadcrust, roasted nuts and moist sensory experience to the baked bread product. The bread product made with the integrated shelf life extender composition was also less hard compared to the control sample.

The bread produced using the subject shelf life extender composition in an integrated delivery system, is not only microbiologically stable after 7 days (not exceeding yeast, mold and total bacteria plate counts deemed safe for bread applications), the bread is soft in texture and sensorially has the “breadcrust” or freshly baked aroma, even after 7 days. This aroma or positive sensory experience is even more surprising when poor quality wheat flour is used in the bread product recipe, as starch degradation typically would occur faster in such bread in the absence of the use of the subject shelf life extender composition.

In another aspect, there is provided an embodiment for a use of an integrated shelf life extending composition for extending the shelf life of a baked bread product containing wheat flour, by addition to a dough mix containing at least a portion of the wheat flour in the baked bread product recipe, characterised in that the shelf life extender composition comprises in weight percent based on the total weight of the shelf life extender composition:
a) about 10 wt. % to about 80 wt. % of at least one fat composition;
b) about 1 wt. % to about 10 wt. % of at least one hydrocolloid adsorbent;
c) about 1 wt. % to about 5 wt. % of at least one glyceride;
d) about 1 wt. % to about 5 wt. % of at least one dough strengthener;
e) about 1 wt. % to about 10 wt. % of at least one flavour component.

The use of the first embodiment may be further characterised by adding to the dough mix about 0.5 wt. % to about 2 wt. % of the shelf life extender composition, based on the total weight of the baked bread product recipe.

The use of the second embodiment may be further characterised by incorporating the dough mix containing the shelf life extender composition into the baked bread product recipe.

The use of any of the previous embodiments, may be characterised in that the baked bread product is white bread.

The use of any of the previous embodiments, may be characterised in that the fat is at least one of palm olein, palm fat, palm shortening, palm stearin, refined, deodorized and bleached palm oil, vegetable oil, canola oil, sunflower oil, coconut oil, or a fatty acid selected from palmitic acid, stearic acid, oleic acid, linoleic acid and lauric acid.

The use of any of the previous embodiments, may be characterised in that the adsorbent is at least one of a hydrocolloid selected from a gum, carboxymethyl cellulose, hydroxypropyl methylcellulose, inulin cellulose, alpha, beta, or gamma cyclodextrins singly or in combination, and oligosaccharides.

The use of any of the previous embodiments, may be characterised in that the gum is selected from xanthan gum, guar gum, tara gum, acacia gum, tragacanth gum, karaya gum, locust bean gum, gellan gum, and cellulose gum.

The use of any of the previous embodiments, may be characterised in that the glyceride is at least one of a monoglyceride, a diglyceride or a medium chain triglyceride of at least one fatty acid.

The use of any of the previous embodiments, may be characterised in that the strengthener is at least one of sodium stearoyl lactylate (SSL), albumin, or egg protein.

The use of any of the previous embodiments, may be characterised in that the flavour component is at least one of fatty acids, lactic acid, propionic acid, lactones, aldehydes, diketones, pyrazines, thiazoles, furfural, acetyl furan, maltol, amino acids or dairy cultures.

It will be understood that the embodiments described herein are merely exemplary, and that one skilled in the art may make variations and modifications without departing from the spirit and scope of the embodiments. All such variations and modifications are intended to be included within the scope of the embodiments as described hereinabove. Further, all embodiments disclosed are not necessarily in the alternative, as various embodiments may be combined to provide the desired result.

1. A method of extending the shelf life of a baked bread product containing wheat flour, comprising providing for addition to a dough mix containing at least a portion of the wheat flour in a baked bread product recipe, an integrated shelf life extender composition which comprises in weight percent based on the total weight of the integrated shelf life extender composition:
a) about 10 wt. % to about 80 wt. % of at least one fat composition;
b) about 1 wt. % to about 10 wt. % of at least one hydrocolloid adsorbent;
c) about 1 wt. % to about 5 wt. % of at least one glyceride;
d) about 1 wt. % to about 5 wt. % of at least one dough strengthener;
e) about 1 wt. % to about 10 wt. % of at least one flavour component.

2. The method of claim 1, further comprising adding to the dough mix about 0.5 wt. % to about 2 wt. % of the integrated shelf life extender composition, based on the total weight of the baked bread product recipe.

3. The method of claim 2, further comprising incorporating the dough mix containing the integrated shelf life extender composition into the baked bread product recipe.

4. The method of claim 1, wherein the baked bread product is white bread.

5. The method of claim 1, wherein the at least one fat composition is at least one of palm olein, palm fat, palm shortening, palm stearin, refined, deodorized and bleached palm oil, vegetable oil, canola oil, sunflower oil, coconut oil, or a fatty acid selected from palmitic acid, stearic acid, oleic acid, linoleic acid, and lauric acid.

6. The method of claim 1, wherein the at least one hydrocolloid adsorbent is at least one of gum, carboxymethyl cellulose, hydroxypropyl methylcellulose, inulin cellulose alpha, beta, gamma cyclodextrins singly or in combination, and oligosaccharides.

7. The method of claim 6, wherein the gum is selected from xanthan gum, guar gum, tara gum, acacia gum, tragacanth gum, karaya gum, locust bean gum, gellan gum, and cellulose gum.

8. The method of claim 1, wherein the at least one glyceride is at least one of a monoglyceride, a diglyceride, or a medium chain triglyceride of at least one fatty acid.

9. The method of claim 1, wherein the at least one dough strengthener is at least one of sodium stearoyl lactylate (SSL), albumin, or egg protein.

10. The method of claim 1, wherein the at least one flavour component is at least one of fatty acids, lactic acid, propionic acid, lactones, aldehydes, ketone, diketones, pyrazines, thiazoles, furfural, acetyl furan, maltol, amino acids, or dairy cultures.

11. The method of claim 1, wherein the integrated shelf life extender composition is made by a method comprising:
melting the at least one fat composition, optionally comprising oil;
adding the at least one glyceride and the at least one dough strengthener to the melted fat/oil composition with agitation or high shear mixing to form a liquid oil phase;
adding the at least one hydrocolloid adsorbent and optionally the at least one flavour component to the liquid oil phase with mixing or agitation to form a homogenized continuous oil phase; and
allowing the homogenized continuous oil phase to cool and solidify.

12. The method of claim 11, wherein the integrated shelf life extender composition is made by a batch mixing process in a heat jacketed vessel, including heating the vessel for melting the at least one fat composition by hot water and/or steam circulation in the vessel jacketing.

13. The method of claim 11, wherein the homogenized continuous oil phase is packaged in a container and allowed to cool and solidify in the packaging container.

14. The method of claim 1, wherein the integrated shelf life extender composition is made by a method comprising:
melting the at least one fat composition, optionally comprising oil;
adding sequentially to the melted fat/oil composition with agitation or high shear mixing:
a) the at least one glyceride and the at least one dough strengthener,
b) the at least one flavour component, water, and other water soluble ingredients, and
c) the at least one hydrocolloid adsorbent,
to form a dispersed aqueous phase water-in-oil emulsion in a continuous non-aqueous phase; and
crystallising the continuous non-aqueous phase by cooling to form a viscous paste.

15. The method of claim 14, wherein the dispersed aqueous phase water-in-oil emulsion in the continuous non-aqueous phase is passed through a dynamic scraped surface heat exchanger to form the viscous paste.

16. A method of making a baked bread product containing wheat flour, having an extended shelf life of up to at least 7 days, comprising:
preparing a sponge mix containing wheat flour by mixing the wheat flour and other ingredients thereof;
proofing the sponge mix;
adding to a dough mix containing at least a portion of the wheat flour in the baked bread product recipe, an integrated shelf life extender composition which comprises in weight percent based on the total weight of the integrated shelf life extender composition:
a) about 10 wt. % to about 80 wt. % of at least one fat composition;
b) about 1 wt. % to about 10 wt. % of at least one hydrocolloid adsorbent;
c) about 1 wt. % to about 5 wt. % of at least one glyceride;
d) about 1 wt. % to about 5 wt. % of at least one dough strengthener;
e) about 1 wt. % to about 10 wt. % of at least one flavour component;
mixing the dough mix containing the integrated shelf life extender composition with the proofed sponge mix to form a mixture;
mixing a shortening component into the mixture to form a shortening component modified mixture;
optionally moulding the shortening component modified mixture;
proofing the shortening component modified mixture; and
baking the proofed, shortening component modified mixture.

17. The method of claim 16, wherein the integrated shelf life extender composition is prepared by a method comprising:
melting the at least one fat composition, optionally comprising oil;
adding the at least one glyceride and the at least one dough strengthener to the melted fat/oil composition with agitation or high shear mixing to form a liquid oil phase;
adding the at least one hydrocolloid adsorbent and optionally the at least one flavour component to the liquid oil phase with mixing or agitation to form a homogenized continuous oil phase; and
allowing the homogenized continuous oil phase to cool and solidify.

18. The method of claim 16, wherein the integrated shelf life extender composition is prepared by a method comprising:
melting the at least one fat composition, optionally comprising oil;
adding sequentially to the melted fat/oil composition with agitation or high shear mixing:
a) the at least one glyceride and the at least one dough strengthener,
b) the flavour component, water, and other water soluble ingredients, and
c) the at least one hydrocolloid adsorbent,
to form a dispersed aqueous phase water-in-oil emulsion in a continuous non-aqueous phase; and
crystallising the continuous non-aqueous phase by cooling to form a viscous paste.
